(19) United States
(12) Patent Application Publication
(10) Pub. No.: US 2016/0065470 A1
(43) Pub. Date: Mar. 3, 2016

(54) NETWORK DEVICE AND METHOD FOR ROUTING

(71) Applicant: HON HAI PRECISION INDUSTRY CO., LTD., New Taipei (TW)

(72) Inventor: Chi-Han HUANG, New Taipei (TW)

(21) Appl. No.: 14/718,801

(22) Filed: May 21, 2015

(30) Foreign Application Priority Data
Sep. 3, 2014 (TW) 103130358

(51) Int. Cl. H04L 12/741; H04L 29/12

(52) U.S. Cl. CPC H04L 45/745; H04L 61/1511; H04L 61/2007

(57) ABSTRACT

A network device records several different predetermined routing strategies each based on different network environments, and WAN interfaces respectively corresponding to the routing strategies. The network device receives DNS query packet sent by the client, selects a routing strategy from the different predetermined routing strategies, and selects a corresponding WAN interface according to the selected routing strategy. The DNS query packet is transmitted to a DNS server via the corresponding WAN interface.

### CROSS-REFERENCE TO RELATED APPLICATIONS

This application claims priority to Taiwanese Patent Application No. 102127275 filed on Jul. 30, 2013, the contents of which are incorporated by reference herein.

### FIELD

The subject matter herein generally relates to network communications, and more particularly to a method of a network device for routing.

### BACKGROUND

Clients may communicate with multiple wide area networks (WANs) via a net-work device, such as a router. The common internet protocol used to communicate over the WAN is called the Internet protocol (“IP”). There are different versions of the IP protocol including the common IP version 4 (herein also referred to as “IPv4”) and the more recent IP version 6 (herein also referred to as “IPv6”). When a client in the local area network wants to access the WANs, a network device is needed to select an appropriate routing strategy and a WAN interface corresponding to the routing strategy according to a destination address of the client. In order to select a WAN interface from multiple WAN interfaces as a connect interface, the network device sends a request packet to all the WANs, receives response packets from multiple WANS, and selects the appropriate routing strategy according to all response packets sent from the WANs. It takes a lot of time to select a appropriate routing strategy by using above-described method, this is not the optimal user experience.

### BRIEF DESCRIPTION OF THE DRAWINGS

FIG. 1 is a diagrammatic view of an embodiment of a network device in communication with wide area networks and clients.

FIG. 2 is a block diagram of an embodiment of function modules of the network device.

FIG. 3 is a flowchart of an embodiment of a routing method.

### DETAILED DESCRIPTION

The embodiments are illustrated by way of example and not by way of limitation in the figures of the accompanying drawings in which like references numerals indicate similar elements. It should be noted that references to “an” or “one” embodiment in this disclosure are not necessarily to the same embodiment, and such references can mean “at least one.”

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

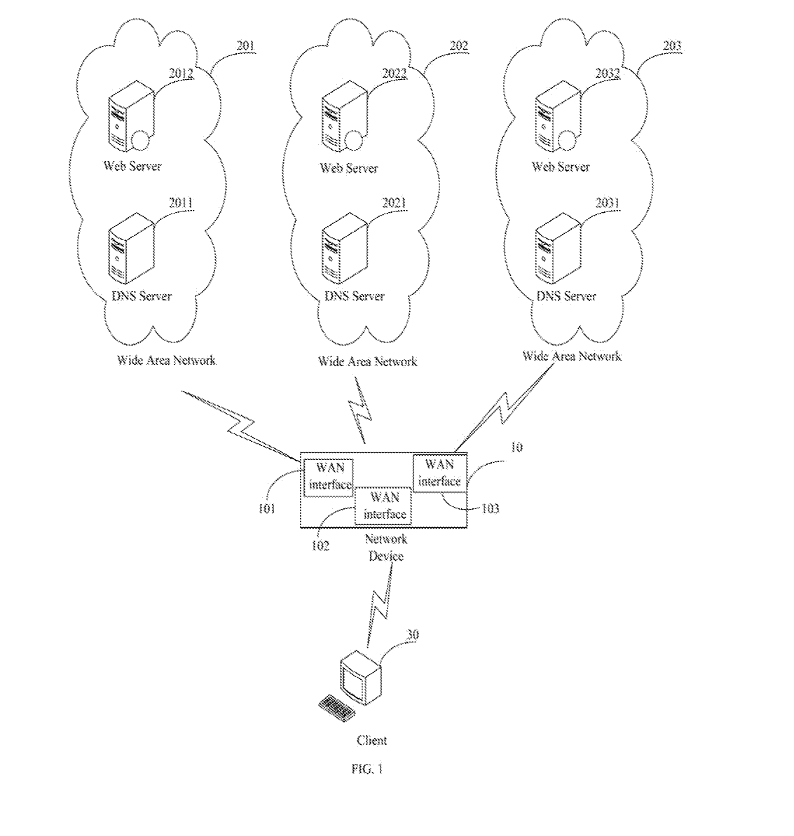

FIG. 1 is a diagrammatic view of a network device 10 in communication with a client 30, and multiple wide area networks (WANs), 201, 202, 203. The client 30 is connected to the multiple WANs 201, 202, 203 via the network device 10 wirelessly or wires. The network device 10 includes multiple WAN interfaces 101, 102, 103 utilized to respectively connect to the multiple WANs 201, 202, 203. The multiple WANs 201, 202, 203 include Domain Name Service (DNS) servers 2011, 2021, 2031 and Web servers 2012, 2022, 2032. The DNS servers 2011, 2021, 2031 are utilized to provide domain name resolution services, and the Web servers 2012, 2022, 2032 are utilized to provide network services, such as videos, games and webpages.

In this embodiment, the network device 10 can be a router, switch, or gateway; the client 30 can be a personal computer or smart phone; the number of clients 30 can be one or more than one; the multiple WANs 201, 202, 203 can use different versions of IP, such as IPv4 or IPv6; the multiple WANs 201, 202, 203 can be provided by different internet service providers (ISPs), such as China Telecom, China Mobile and China Unicom.

In the embodiment, when the client 30 accesses a web site, the network device 10 receives a DNS query packet sent by the client 30, and automatically selects a suitable routing strategy. Then the network device 10 sends the DNS query packet to one of the DNS servers via the corresponding WAN interface according to the matching routing strategy, to obtain an IP address of the corresponding Web server corresponding to the web site. The network device 10 transmits an IP packet sent by the client 30 to allow the client 30 to successfully access the web site. Taking WAN 201 as an example, the network device 10 sends the DNS query packet to DNS server 2011 via the WAN interface 101, to obtain the IP address of the Web server 2012 corresponding the web site.

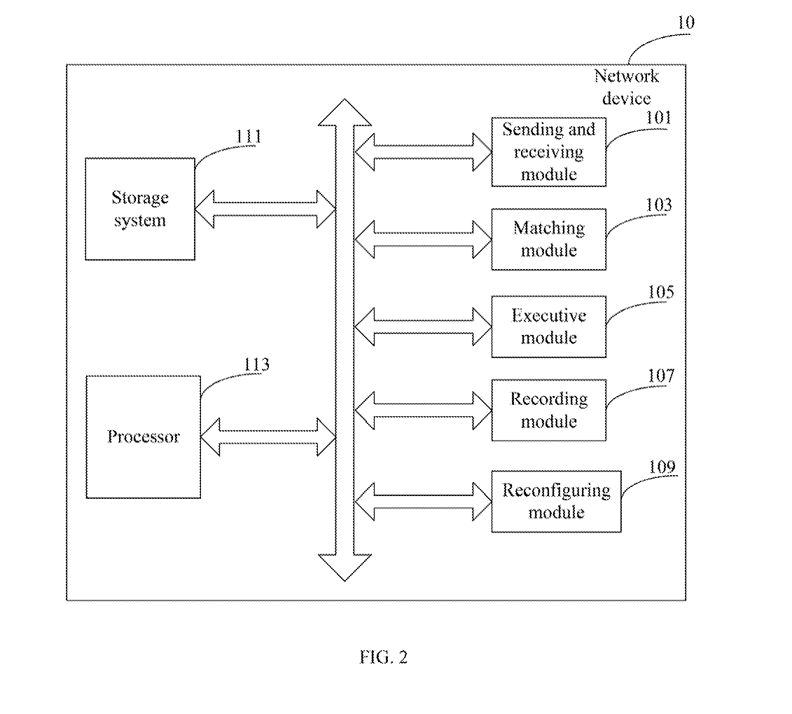

FIG. 2 is a block diagram of an embodiment of function module of the network device 10. In the embodiment, the network device 10 includes a sending and receiving module 101, a matching module 103, an executive module 105, a recording module 107, a reconfiguring module 109, a storage system 111, and a processor 113. The modules of the network device 10 comprises one or more software programs in the form of computerized codes. The storage system 111 stores the computerized codes, and the processor 113 executes instructions of the computerized codes to provide functions for the modules 101-109.

The recording module 107 records multiple different predetermined routing strategies, and multiple WAN interfaces corresponding to the routing strategies. The network device 10 is in communication with the different WANs 201, 202, 203 via the multiple WAN interfaces 101, 102, 103. The network device 10 presets the routing strategies corresponding to the multiple WAN interfaces manually or automatically according to the different network environments. In the embodiment, thetotal routing strategies include: a first routing strategy, a second routing strategy, a third routing strategy, and a fourth routing strategy. The first routing strategy includes a predetermined static routing table. The second routing strategy includes a domain search list generated by dynamic host configuration protocol (DHCP). The third routing strategy corresponds to a DNS query packet based on IPv4. The fourth routing strategy corresponds to a DNS query packet based on IPv6. In other embodiments, the routing strategies can also include other strategies based on the network environment of the WANs to which the network device 10 is connected.

The sending and receiving module 101 receives the DNS query packet sent by the client 30. In detail, the client 30 sends the DNS query packet by inputting a domain name in an explorer. The matching module 103 selects a suitable routing strategy from the total routing strategies for the DNS query packet and a corresponding WAN interface according to the suitable routing strategy.

In this embodiment, the matching module 103 searches the routing strategies from the first routing strategy to the fourth routing strategy in sequence. Firstly, the matching module 103 determines whether the first routing strategy matches the DNS query packet by searching the static routing table. In detail, when the first routing strategy contains the same information as the DNS query packet, the first routing strategy is determined as matching the DNS query packet. For example, when the DNS query packet includes a destination IP address such as —“www.baidu.com”, the first strategy includes the same destination IP address, —“www.baidu.com”, and it is determined that the first routing strategy matches the DNS query packet. The corresponding WAN interface is selected for transmitting the DNS query packet. If the first routing strategy does not match the DNS query packet, the matching module 103 determines whether the second routing strategy matches the DNS query packet by searching list of domains. In detail, when the second routing strategy contains the same information as the DNS query packet, the second routing strategy is determined as to matching the DNS query packet. If the second routing strategy does not match the DNS query packet, the matching module 103 determines whether the third routing strategy matches the DNS query packet by determining whether the internet protocol of the DNS query packet is based on IPv4. When the DNS query packet is based on IPv4, the third routing strategy matches the DNS query packet and the corresponding WAN interface is selected for transmitting the DNS query packet. If the third routing strategy does not match the DNS query packet, the matching module 103 determines whether the fourth routing strategy matches the DNS query packet by determining whether the internet protocol of the DNS query packet is based on IPv6. When the DNS query packet is based on IPv6, the fourth routing strategy matches the DNS query packet and the corresponding WAN interface is selected for transmitting the DNS query packet. In other embodiments, the matching module 103 can also check sequentially from the fourth routing strategy to the first routing strategy.

The executive module 105 transmits the DNS query packet to the corresponding DNS server 2011 via the corresponding WAN interface 101, and receives a response packet sent from the corresponding DNS server 2011. The response packet contains an IP address of the web server which corresponds to the DNS query packet. In the embodiment, when the executive module 105 does not receive a response packet during a first time period, matching module 103 selects a next routing strategy for the DNS query packet, according to the method descrbied above. For example, when the first routing strategy is selected for transmitting the DNS query packet, the DNS query packet is transmitted to the DNS server 2011. If the executive module 105 does not receive a response packet during the first time period, then the matching module 103 will determine whether the second routing strategy matches the DNS query packet. The executive module 105 transmits the DNS query packet according to new matching routing strategy and performs the above steps as described above, until the executive module 105 receives a response packet. When the executive module 105 receives a response packet during the first time period, the sending and receiving module 101 transmits the IP packet according to the IP address information contained in the response packet.

The reconfiguring module 109 is configured to update the routing table information stored in the storage system 111. When executive module 105 receives the response packet, the reconfiguring module 109 determines whether it is the first time that the DNS query packet is received by the network device 10. When the DNS query packet is received by the network device 10 for the first time, the reconfiguring module 109 adds the IP address information corresponding to the DSN query packet to the storage system 111. The sending and receiving module 101 then transmits the IP packet sent by the client 30 according the IP address information stored in the storage system 111 as a preference. When the DNS query packet is not received by the network device 10 for the first time, the reconfiguring module 109 updates the existing IP address information in the storage system 111. In the embodiment, when the DNS query packet is received by the network device 10, the reconfiguring module 109 sets a second time period for the DNS query and the storage system 111 stores the second time period. If the DNS query packet is not received by the network device 10 again during the second time period, the reconfiguring module 109 deletes the corresponding IP address information and the second time period which are both stored in the storage system 111.

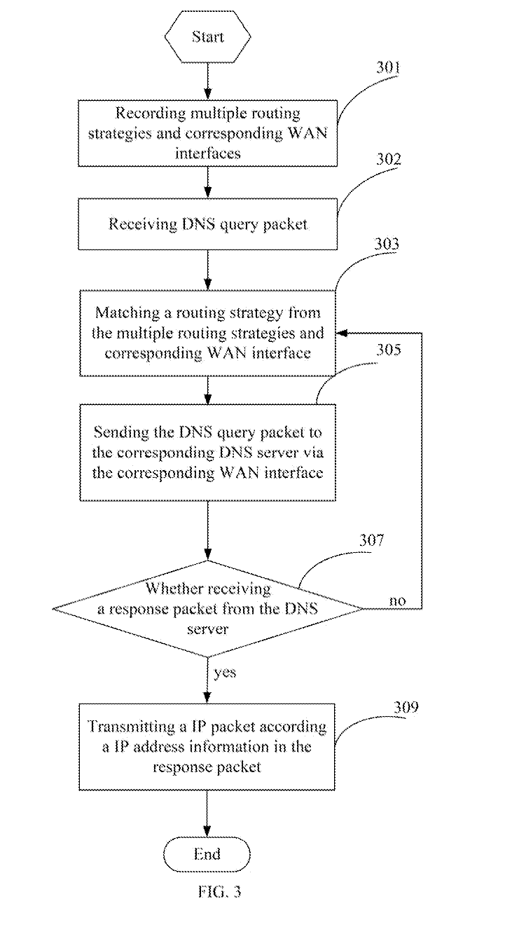

FIG. 3 is a flowchart of one embodiment of an example routing method in accordance with the present disclosure, the method is utilized network device 10 of FIG. 2 In the described embodiment, the method is carried out in the application environment illustrated in FIG. 1, and is executed by the sending and receiving module 101, the matching module 103, the executive module 105, the recording module 107, the reconfiguring module 109. the storage system 111 and the processor 113 of the network device 10. In block S301, a recording module of the network device 10 records different predetermined routing strategies depending on different network environments, and multiple WAN interfaces corresponding to the routing strategies. The network device 10 is in communication with the different WANs 201, 202, 203 via the multiple WAN interfaces 101, 102, 103. The network device 10 presets the total routing strategies corresponding to the multiple WAN interfaces either manually or, according to the different network environments, automatically. In the embodiment, the total routing strategies include: a first routing strategy, a second routing strategy, a third routing strategy, and a fourth routing strategy. The first routing strategy includes a predetermined static routing table. The second routing strategy includes a list of domains generated by dynamic host configuration protocol (DHCP). The third routing strategy corresponds to a DNS query packet based on IPv4 protocol. The fourth routing strategy corresponds to a DNS query packet based on IPv6 protocol. In other embodiments, the routing strategies can also include other strategies base on the network environment of the WANs to which the network device 10 is connected.

At block 302, the sending and receiving module receives the DNS query packet sent by the client 30. In detail, the client 30 sends the DNS query packet by inputting domain name in an explorer.

At block 303, the matching module selects one routing strategy from the total routing strategies for the DNS query packet, and selects a WAN interface according to the selecting routing strategy for transmitting the DNS query packet. In this embodiment, the matching module searches the routing strategies from the first routing strategy to the fourth routing strategy in sequence. Firstly, the matching module determines whether the first routing strategy matches the DNS query packet by searching the static routing table. In detail, when the first routing strategy contains the same information as the DNS query packet, the first routing strategy is determined as matching the DNS query packet. For example, when the DNS query packet includes a destination IP address such as—“www.baidu.com”, the first strategy includes the same destination IP address, —“www.baidu.com.” In this case, it is determined that the first routing strategy matches the DNS query packet, and the corresponding WAN interface is selected for transmitting the DNS query packet. If the first routing strategy does not match the DNS query packet, the matching module determines whether the second routing strategy matches the DNS query packet by searching list of domains. In detail, when the second routing strategy contains the same information as the DNS query packet, the second routing strategy is determined as matching the DNS query packet. If the second routing strategy does not match the DNS query packet, the matching module determines whether the third routing strategy matches the DNS query packet by determining whether the internet protocol of the DNS query packet is based on IPv4 protocol. When the DNS query packet is bases on IPv4 protocol, the third routing strategy matches the DNS query packet and the corresponding WAN interface is selected for transmitting the DNS query packet. If the third routing strategy does not match the DNS query packet, the matching module 103 determines whether the fourth routing strategy matches the DNS query packet by determining whether the internet protocol of the DNS query packet is based on IPv6 protocol. When the DNS query packet is based on IPv6, the fourth routing strategy matches the DNS query packet and the corresponding WAN interface is selected for transmitting the DNS query packet. In other embodiment, the matching module 103 can also check sequentially from the fourth routing strategy to the first routing strategy.

At block 305, the executive module transmits the DNS query packet to the corresponding DNS server 2011 via the corresponding the WAN interface 101.

At block 307, the executive module determines whether the network device 10 receives a response packet from the corresponding DNS server 2011. The response packet contains an IP address information of the web server corresponding to the DNS query packet. If the DNS server can resolve the DNS query packet, the DNS server 2011 sends a response packet to the executive module. The response packet contains IP address information corresponding to the DNS query packet. In the embodiment, when the executive module 105 does not receive a response packet during a first time period, block S303 is implemented. If the executive module receives a response packet during the first time period, block 309 is implemented.

At block 309, the sending and receiving module transmits the IP packet according to the IP address information contained in the response packet.

While various embodiments and methods have been described above, it should be understood that they have been presented by way of example only and not by way of limitation. Thus the breadth and scope of the present disclosure should not be limited by the above-described embodiments, and should be at least commensurate with the following claims and their equivalents.

What is claimed is:

1. A network device configured to be connectable with a client device, the network device comprising:
multiple wireless area network (WAN) interfaces;
at least one processor in signal communication with the multiple wireless area network (WAN) interfaces;
at least one storage system in signal communication with the processor; and
one or more programs stored in the storage system and executable by the processor, the one or more programs comprising instructions for:
recording multiple different predetermined routing strategies based on different network environments and WAN interfaces corresponding to the routing strategies respectively;
receiving a domain name system (DNS) query packet sent by the client device;
selecting one routing strategy from the multiple different predetermined routing strategies, and selecting one corresponding WAN interface according to the selected routing strategy;
transmitting the DNS query packet to a DNS server via the corresponding WAN interface.

2. The network device of claim 1, wherein the one or more programs further comprises instructions for:
detecting whether receiving a response packet from the corresponding DNS server, the response packet comprising an IP address information corresponding to the DNS query packet; and
transmitting an IP packet sent by the client device to a terminal which has the IP address information, when receiving a response packet from the corresponding DNS server.

3. The network device of claim 2, wherein the one or more programs further comprises instructions for:
selecting a next routing strategy when not receiving the response packet from the DNS server.

4. The network device of claim 1, wherein the multiple different predetermined routing strategies comprise a first routing strategy comprising a predetermined static routing table and a second routing strategy comprising a list of domains generated by DCHP which comprises opt-119 based on Ipv4 and opt-24 based on Ipv6.

5. The network device of claim 4, wherein selecting one routing strategy from the multiple different predetermined routing strategies further comprises:
searching the predetermined static routing table and the domain search list in sequence;
detecting whether the predetermined static routing table and the domain search list comprising the same information of the DNS query packet; and
selecting the routing strategies comprising the same information of the DNS query packet as the suitable routing stratege corresponding to the DNS query packet.

6. The network device of claim 5, wherein the multiple different predetermined routing strategies further comprise a third routing strategy corresponding to DNS query packets based on IPv4 and a fourth routing strategy corresponding to DNS query packets based on IPv6.

7. The network device of claim 6, wherein selecting a routing strategy from the multiple different predetermined routing strategies further comprises:
detecting the type of the DNS query packets;
selecting the third routing strategy when the type of the DNS query packets is Ipv4; and
selecting the fourth routing strategy when the type of the DNS query packets is Ipv6.

8. The network device of claim 1, wherein the one or more programs further comprises instructions for:
determining whether the DNS query packet is received for the first time when receiving a response packet from the corresponding DNS server;
updating the predetermined routing strategies by adding the IP address information corresponding the DNS query packet to the predetermined routing strategies, when the DNS query packet is received for the first time; and
transmitting an IP packet sent by the client device by preferentially using the updated routing table.

9. The network device of claim 8, wherein the one or more programs further comprising instructions for:
updating an IP address information corresponding to the DNS query packet of the storage system, when a DNS query packet is not received for the first time.

10. The network device of claim 9, wherein the one or more programs further comprising instructions for:
setting a deadline time for recieving the DNS query packet again; and
deleting the IP address information and the deadline time corresponding to the DNS query packet, when a DNS query packet is not received during the deadline time.

11. A routing method of a network device, the internet device configured to be connectable with a client device and comprising multiple wireless area network (WAN) interfaces, the method comprising:
recording multiple different predetermined routing strategies based on different network environments, and WAN interfaces corresponding to the routing strategies respectively;
receiving a domain name system (DNS) query packet sent by the client device;
selecting one routing strategy from the multiple different predetermined routing strategies, and selecting one corresponding WAN interface according to the selected routing strategy;
transmitting the DNS query packet to a DNS server via the corresponding WAN interface.

12. The routing method of claim 11, further comprises:
detecting whether receiving a response packet from the corresponding DNS server, the response packet comprising an IP address information corresponding to the DNS query packet; and
transmitting an IP packet sent by the client device to a terminal which has the IP address information, when receiving a response packet from the corresponding DNS server.

13. The routing method of claim 12, further comprises:
selecting a next routing strategy when not receiving the response packet from the DNS server.

14. The routing method of claim 11, wherein the multiple different predetermined routing strategies comprise predetermined static routing table and a second routing strategy comprising a list of domains generated by DCHP which comprises opt-119 based on Ipv4 and opt-24 based on Ipv6.

15. The routing method of claim 14, wherein selecting one routing strategy from the multiple different predetermined routing strategies further comprises:
searching the predetermined static routing table and the domain search list in sequence;
detecting whether the predetermined static routing table and the domain search list comprising the same information of the DNS query packet; and
selecting the routing strategies comprising the same information of the DNS query packet as the suitable routing stratege corresponding to the DNS query packet.

16. The routing method of claim 15, wherein the multiple different predetermined routing strategies further comprise a third routing strategy corresponding to DNS query packets based on IPv4 and a fourth routing strategy corresponding to DNS query packets based on IPv6.

17. The routing method of claim 16, wherein selecting a routing strategy from the multiple different predetermined routing strategies further comprises:
detecting the type of the DNS query packets;
selecting the third routing strategy when the type of the DNS query packets is Ipv4; and
selecting the fourth routing strategy when the type of the DNS query packets is Ipv6.

18. The routing method of claim 11, further comprises:
determining whether the DNS query packet is received for the first time when receiving a response packet from the corresponding DNS server;
updating the predetermined routing strategiesby adding the IP address information corresponding the DNS query packet to the predetermined routing strategies, when the DNS query packet is received for the first time; and
transmitting an IP packet sent by the client device by preferentially using the updated routing table.

19. The routing method of claim 18, further comprises:
updating an IP address information corresponding to the DNS query packet of the storage system, when a DNS query packet is not received for the first time.

20. The routing method of claim 19, further comprises:
setting a deadline time for recieving the DNS query packet again; and
deleting the IP address information and the deadline time corresponding to the DNS query packet, when a DNS query packet is not received during the deadline time.
